(19) United States
(12) Patent Application Publication
(10) Pub. No.: US 2016/0174468 A1
(43) Pub. Date: Jun. 23, 2016

(54) DECORATIVE WREATH DISPLAY

(71) Applicant: Robin Adams, Gary, TX (US)

(72) Inventor: Robin Adams, Gary, TX (US)

(21) Appl. No.: 14/576,975

(22) Filed: Dec. 19, 2014

(51) Int. Cl. A01G 5/04; F16B 1/00

(52) U.S. Cl. CPC A01G 5/04; F16B 1/00; F16B 2001/0035

(57) ABSTRACT

A decorative wreath display which provides for the selective attachment and removal of seasonal decoration items by magnetic fixation thereto. A magnet attachment frame is secured to a base wreath support. The attachment frame has multiple fittings for threadably receiving a plurality of upstanding magnetic attachment surface standards about the perimeter edges of the decorated wreath.

### BACKGROUND OF THE INVENTION

1. Technical Field

This invention relates to decorative displays, such as wreaths and other seasonal themed decorations that are used throughout the year.

The use of wreaths featuring natural or artificial elements such as foliage and plant material associated with the season, holiday or event. Such wreaths are typically formed from a support base of multiple spaced wire rings secured together onto which decorative material can be attached. Such attachment and removal usually involves florist wire or the like and requires a high degree of effort to alternately remove and reattach when changing the seasonal display.

2. Description of Prior Art

Prior art devices to aid in the attachment and formation of natural and artificial material based wreaths can be seen, for example, in U.S. Pat. Nos. 2,227,187, 5,299,382 and U.S. Publications 2006/0117629, 2009/0302184 and 2012/0052218.

In U.S. Pat. No. 2,227,187 a decorative wreath can be seen having a wire frame formed of multiple sized rings secured to one another in concentric and vertical spaced relation by multiple contoured interconnecting support frame wires.

U.S. Pat. No. 5,299,382 claims a ring shaped support frame for wreaths having a first horizontal portion to retain decorative material thereon and a second vertical spaced ring portion defined by a lip extending along the periphery of the first portion to increase the strength of the frame.

U.S. Publication 2006/0117629 discloses a reusable decorative display formed from multiple wire rings secured to one another to define a three dimensional support frame by multiple transverse connection wire elements. A plurality of alligator clips are magnetically attached about the wire frame onto which the decorative material can be selectively grasped and held.

### SUMMARY OF THE INVENTION

The present invention is directed to a decorative wreath accessory that provides for a magnetic attachment and removal of seasonal themed decorations to a mounting frame that is added to an existing wreath support grid work onto which the decorative elements are placed to define the wreath. Multiple upstanding magnet receiving attachment surfaces are prepositioned about the mounting frame providing elevated spaced planar surfaces onto which magnetic backed decorations can be selectively applied and reapplied.

### DESCRIPTION OF THE DRAWINGS

FIG. 1 is a perspective view of the decorative wreath assembly of the invention.

FIG. 2 is a front elevational view thereof.

FIG. 3 is a bottom plan view of the wreath assembly with inserts partially positioned therein.

FIG. 4 is an enlarged top plan view of a magnetic attachment surface element.

FIG. 5 is an exploded side elevational view thereof.

FIG. 6 is a front elevational view of the wreath assembly with decorative elements shown in broken lines.

FIG. 7 is a bottom plan view of the decorative wreath assembly with inserts and decorations shown in broken lines.

### DETAILED DESCRIPTION OF THE INVENTION

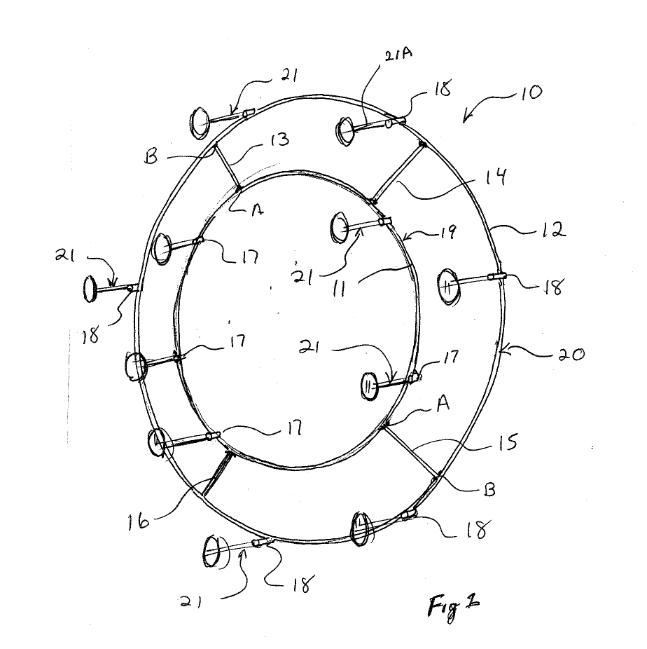

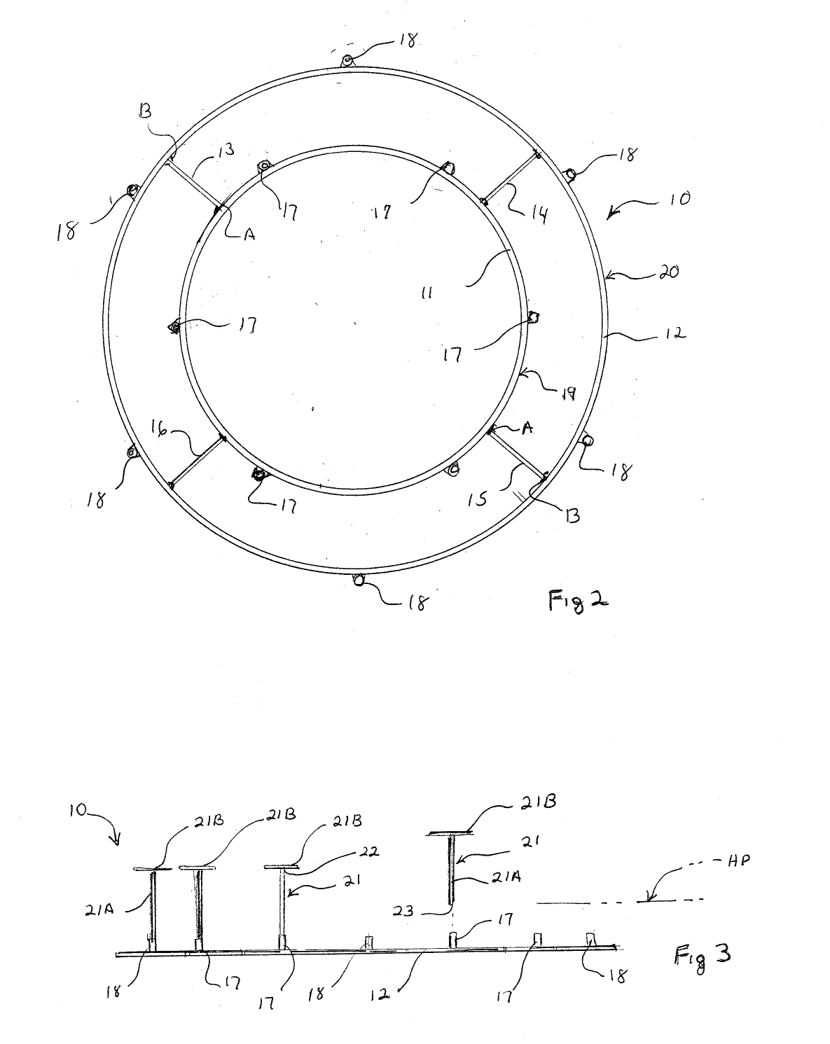

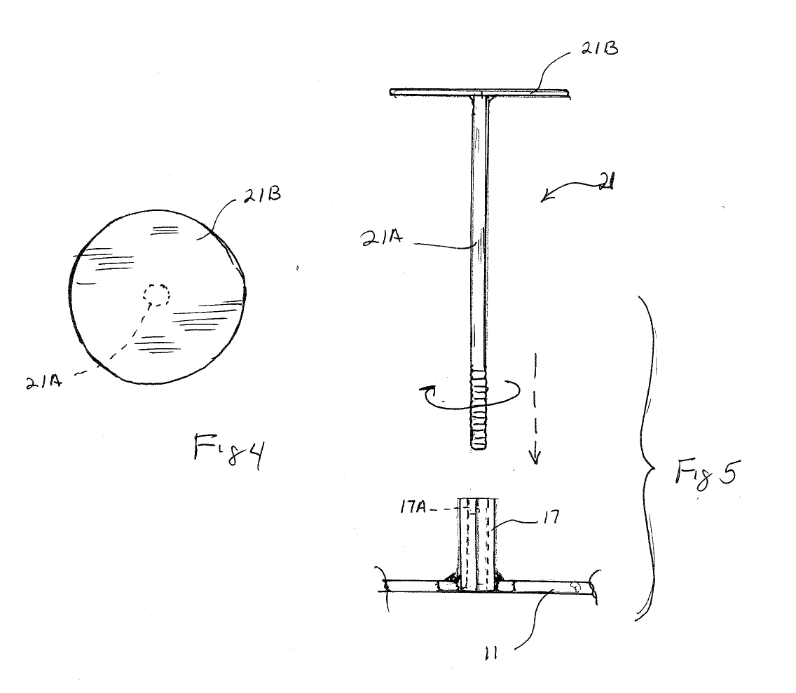

Referring to FIGS. 1, 2 and 3 of the drawings, a magnetic wreath assist device of the invention can be seen having an adjustable interchangeable support frame 10 with a pair of spaced different sized annular wire rings 11 and 12 secured to one another in planar relation. The inner wire ring 11 and the outer wire ring 12 are secured in spaced centralized relation by multiple interengaging wire connecting elements 13, 14, 15, and 16 preferably by welding at corresponding oppositely disposed engagement points A and B for each connection wire elements.

Each of the interconnected wire rings 11 and 12 having a plurality of annularly spaced upstanding mounting sockets 17 and 18 respectively positioned there about. The orientation of the mounting sockets 17 and 18 on each of the respective wire rings 11 and 12 is such so as to provide a staggered relationship between each of the sockets 17 on ring 11 and sockets 18 on ring 12. This arrangement assures uniform disbursements of the upstanding mounting sockets 17 and 18 overall. Each of the respective sockets 17 and 18 are secured to its corresponding ring around its respective outer perimeter edges 19 and 20 preferably by welding so as to position the sockets at right angles thereto as to be upstanding to the horizontal plane HP of the rings as best seen in FIGS. 3 and 5 of the drawings.

A plurality of magnet attachment surface standards 21 are removably secured within the respective sockets 17 and 18 with each of the magnetic attachment surface elements 21 having an elongated rod portion 21A with a surface engagement disk 21B secured on one end at 22. The remaining free end 23 of the rod is threaded inwardly therefrom for threaded engagement within a correspondingly internally threaded socket bore 17A and 18A as best seen in FIG. 5 of the drawings.

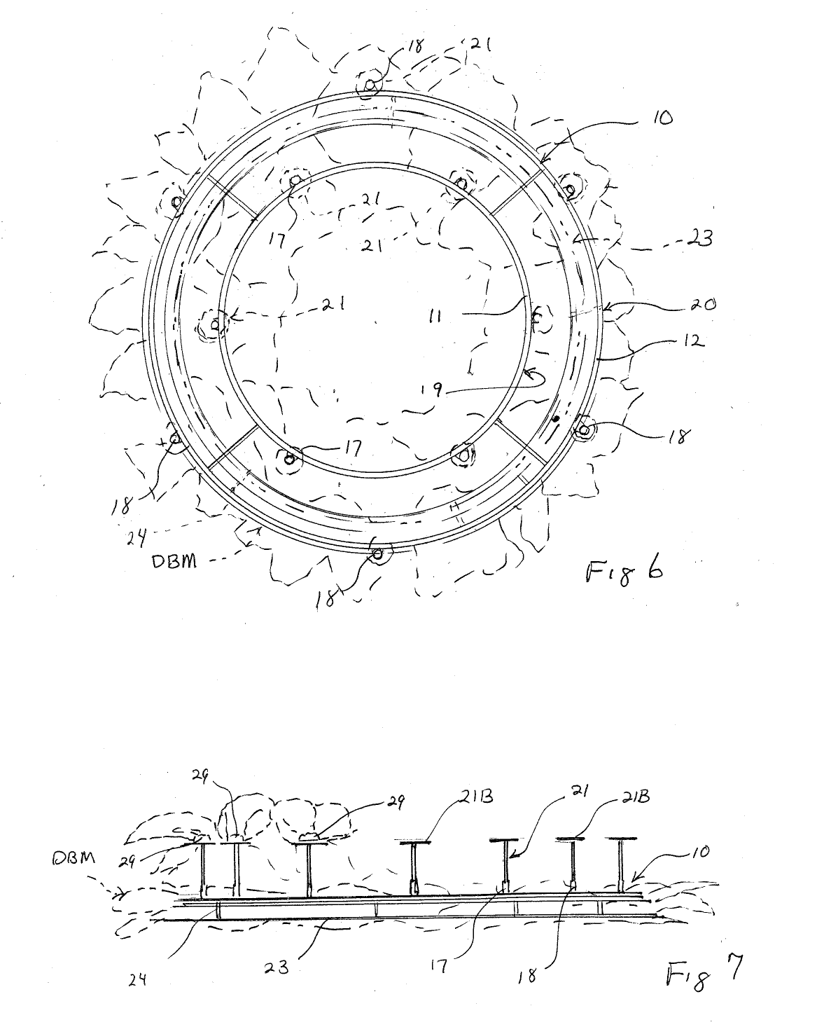

In use application, the wreath assist device 10 of the invention is secured to a conventional wreath base framework 23, well known in the art, as illustrated in broken lines in FIG. 5 and in solid lines in FIG. 7 of the drawings having multiple interconnected annular wire structure and is secured thereto by multiple independent flexible ties 24 indicated generally as again will be well known within the art.

In typical decorative wreath construction, a decorative base material DBM is typically applied first to the base framework 23 as represented in broken lines in FIGS. 6 and 7 of the drawings in the example, but may be applied in any preference orientation.

It will be seen that once the interchangeable support frame 10 is secured to the base framework 23, as noted, having the decorative base material DBM applied in place, the magnetic attachment surface standards 21 can then be selectively inserted and rotationally received within the individual threaded sockets 17 and 18 as hereinbefore described.

The decorated base framework 23 and attached support frame 10 with its plurality of extending magnetic attachment surface elements 21 provides for magnetic attachment and removal of seasonal decorative wreath elements 28 indicated generally in broken lines represented in FIG. 7 of the drawings which may be dependent on the seasonal requirements. The decorative seasonal wreath elements 28 all have permanent magnets 29 positioned within to assure magnetic attraction and attachment as hereinbefore described.

It will be well understood that alternate magnetic wreath assist support frame configurations may be made such as the use of a singular annular wire ring with its perimeter attached mounting sockets for receiving corresponding magnetic engagement surface standards 21 for different wreath construction venues that may be required. Also a variety of substituted materials may be made within the scope of the enabling disclosures such as synthetic resin for certain non-magnetic attachment elements within its construction.

It will thus be seen that a new and novel magnet wreath assist device of the invention has been illustrated and described which can be easily applied to a new or existing wreath support base frame thereby allowing the use of the multiple upstanding magnetic attachment standards the interengagement and removal of seasonally decorative elements easily and quickly which was heretofore not possible.

It will therefore be evident that various changes and modifications may be made therein without departing from the spirit of the invention. Therefore I claim:

1. A decorative display comprising,
an interchangeable support frame,
multiple magnet attachment elements on said support frame to selectively retain decorative items thereon,
magnets in said decorative element for magnetically attaching to said magnetic attachment elements on said support frame.

2. The decorative display set forth in claim 1 wherein said support frame has multiple mounting sockets for receiving said magnet attachment elements.

3. The decorative display set forth in claim 1 wherein said magnet attachment elements comprises,
a metallic attachment disk and a support rod extending therefrom.

4. The decorative display set forth in claim 1 wherein said interchangeable support frame comprises,
at least one annular wire ring selectively retained to a wreath based framework.

5. The decorative display set forth in claim 2 wherein said mounting sockets are threaded internally.

6. The decorative display set forth in claim 3 wherein said support rod is threaded for rotational registration within said mounting sockets.

7. The decorative display set forth in claim 1 wherein said magnet attachment elements are upstanding from said support frame.

8. A decorative display structure to support decorative elements in a selected arrangement comprising,
a support frame secured to a base frame,
multiple magnet receiving standards upstanding from said support frame,
magnet enabled decorative items selectively attached to said magnet receiving standards.

9. The decorative display structure set forth in claim 8 wherein said support frame has multiple mounting sockets thereabout for selectively receiving said respective magnet receiving standards.

10. The decorative display structure set forth in claim 8 wherein said support frame comprises,
at least one annular wire ring.

11. The decorative display structure set forth in claim 8 wherein said magnet receiving standards comprise,
a magnet engagement portion and a rod extending therefrom.
